(19) United States
(12) Patent Application Publication
(10) Pub. No.: US 2015/0248141 A1
(43) Pub. Date: Sep. 3, 2015

(54) SUPPORTIVE DOCKING MECHANISM

(71) Applicant: MATHEW LEFF, Union, NJ (US)

(72) Inventors: JODY S. SINGLETON, Broomfield, CO (US); MATHEW LEFF, Union, NJ (US); VINCENT P. WILLIAMS, Littleton, CO (US)

(73) Assignee: Mathew Leff, Union, NJ (US)

(21) Appl. No.: 14/194,139

(22) Filed: Feb. 28, 2014

(51) Int. Cl. G06F 1/16; H02J 7/00

(52) U.S. Cl. CPC G06F 1/1632; H02J 7/0044

(57) ABSTRACT

A docking apparatus having a housing and a retention support mechanism. The housing provides back support for a docked device. The retention support mechanism is coupled to the housing and includes and upper support arm and a lower connecting arm. Upon insertion of the device in a slot within a top face of the housing, the upper support arm is raised and the lower connecting arm is lowered. When the device travels to the docked position, the lower connecting arm enables a connector on the device to couple to a corresponding connector within the housing, and the upper arm is raised to a point above the top face of the housing to support a back of the device. When the device is removed, the upper support arm retracts fully into the housing such that no part of the upper support arm protrudes past a plane defined by the top face.

### BACKGROUND OF THE INVENTION

1. Field of the Invention

This invention relates in general to the field of docking mechanisms, and more particularly to an apparatus for docking a mobile phone and/or a tablet computer.

2. Description of the Related Art

One would be hard pressed today to find anyone in this country over the age of 16 who does not carry a cell phone. The cell phone industry is undergoing exponential growth, not only in this country, but all over the world. In fact, it is well known that the over twenty percent of the adult population in the United States do not even have a traditional landline telephone. In addition to those who do not own a conventional telephone, nearly ninety percent of the adult population owns a wireless phone.

And the usage of cell phones is increasing as well over the use of traditional landline telephone coverage. In fact, one in seven adults now uses only cell phones. Whereas in the past cell phones were used when a landline was not available or under emergency conditions, lower carrier rates, affordability of family packages, and free mobile-to-mobile or friend-to-friend promotions have fostered in significant increases in usage. It is not uncommon today to walk into any public forum or facility and notice a majority of the people there talking on their cell phones.

In more recent years, tablet computers have taken off in terms of sales. Although not as ubiquitous as mobile phone, tablet computer usage both personal and professional is increasing like the increase in cell phone usage in earlier years.

As one skilled in the art will appreciate, both cell phones and tablet computers are rechargeable devices. That is, batteries internal to the devices provide for a limited period of operation, and then the batteries must be charged in order to permit further operation. And many public facilities (e.g., airports) are now featuring charging areas for use by their patrons.

Not only do these so-called “smart” devices require charging, but they also require synchronization with computer-based or cloud-based data repositories for purposes of managing data (e.g., contacts, calendars, music, photos) on the devices.

When traveling, many users utilize a charging cord that either plugs into a power outlet or USB port on a computer. But when not traveling, such as in an office environment, these users might employ a charging/synchronization dock that sits on a desk or table top. A typical dock allows an installed device (e.g., phone or tablet computer) to be in an upright position to allow a user to see alerts (e.g., call indications, calendar reminders, text message notifications) that are displayed. And it is desirable as well to allow the user to access controls (e.g., keys and touchscreen controls) on the device when docked.

The present inventors have observed that many present day docks provide no back support for installed devices. That is, when a user attempts to press a button or touchscreen on a docked device, the device decouples from the dock, the dock falls over, or undue torque is transferred to a corresponding connector on the dock. To alleviate these problems, more recent advances have provided docks that include a fixed back support. That is, the back support is fixed at a level, say one half inch, above the level that the bottom of installed device is at.

And for some environments (e.g., executive office), the present inventors have observed that docks with fixed back supports are aesthetically disadvantageous, particularly when a device is not installed. The present inventors have noted a need in the art to provide for a sleeker look and feel for device docks.

Consequently, what is needed is a docking apparatus that provides for a thin and sleek silhouette when not in use and that also provides for ample back support for a device when in use.

In addition, what is needed is a docking mechanism that had a back support that retracts into a housing when not in use and that raises when in use to provide back support to a docked device.

### SUMMARY OF THE INVENTION

The present invention, among other applications, is directed to solving the above-noted problems and addresses other problems, disadvantages, and limitations of the prior art. The present invention provides a superior solution for charging and optionally synchronizing one or more devices within a sleek housing having retractable back support for the one or more devices. In one embodiment, a docking apparatus is provided. The docking apparatus includes a housing and a retention support mechanism. The housing is configured to couple to and provide back support for a device when the device is inserted in the housing in a docked position. The retention support mechanism is coupled to the housing and includes and upper support arm and a lower connecting arm. Upon insertion of the device in a slot within a top face of the housing, the upper support arm is raised and the lower connecting arm is lowered. When the device travels to the docked position, the lower connecting arm enables a connector on the device to couple to a corresponding connector within the housing, and the upper arm is raised to a point above the top face of the housing to support a back of the device. When the device is removed, the upper support arm retracts fully into the housing such that no part of the upper support arm protrudes past a plane defined by the top face.

One aspect of the present invention contemplates a docking apparatus having a housing and a plurality of retention support mechanisms. The housing is configured to couple to and provide back support for each of a plurality of devices when inserted in the housing in a docked position. The plurality of retention support mechanisms is coupled to the housing. Each of the plurality of retention support mechanisms have an upper support arm and a lower connecting arm. Upon insertion of one of the plurality of devices in a slot within a top face of the housing, the upper support arm is raised and the lower connecting arm is lowered. When the one of the plurality of devices travels to the docked position, the lower connecting arm enables a connector on the one of the plurality of devices to couple to a corresponding connector within the housing, and the upper arm is raised to a point above the top face of the housing to support a back of the one of the plurality of devices. When the one of the plurality of devices is removed, the upper support arm retracts fully into the housing such that no part of the upper support arm protrudes past a plane defined by the top face.

Another aspect of the present invention comprehends a dock having a housing, a first retention support mechanism, and a second retention support mechanism. The housing is configured to couple to and provide back support for a first device and a second device when inserted in the housing in a docked position, where the first and second devices are of a different size and type. The first retention support mechanism is coupled to the housing, and includes a first upper support arm and a first lower connecting arm. Upon insertion of the first device in a first slot within a top face of the housing, the first upper support arm is raised and the first lower connecting arm is lowered. When the first device travels to the docked position, the first lower connecting arm enables a first connector on the first device to couple to a first corresponding connector within the housing, and the first upper arm is raised to a point above the top face of the housing to support a first back of the first device. When the first device is removed, the first upper support arm retracts fully into the housing such that no part of the first upper support arm protrudes past a plane defined by the top face. The second retention support mechanism is coupled to the housing, and includes a second upper support arm and a second lower connecting arm. Upon insertion of the second device in a second slot within the top face of the housing, the second upper support arm is raised and the second lower connecting arm is lowered. When the second device travels to the docked position, the second lower connecting arm enables a second connector on the second device to couple to a second corresponding connector within the housing, and the second upper arm is raised to a point above the top face of the housing to support a second back of the second device. When the second device is removed, the second upper support arm retracts fully into the housing such that no part of the second upper support arm protrudes past a plane defined by the top face.

### BRIEF DESCRIPTION OF THE DRAWINGS

These and other objects, features, and advantages of the present invention will become better understood with regard to the following description, and accompanying drawings where:

FIG. 1 is a diagram illustrating a side view of a docking mechanism according to the present invention featuring an exemplary tablet computer and a mobile telephone shown in corresponding docked positions;

FIG. 2 is a diagram depicting a top view of the docking mechanism of FIG. 1;

FIG. 3 is a diagram featuring a cutaway view of the docking mechanism of FIG. 2 taken along axis A-A;

FIG. 4 is a diagram showing a perspective view of a retention support mechanism according to the present invention in a docked position;

FIG. 5 is a diagram illustrating a front view of the retention support mechanism of FIG. 4 in a retracted position; and

FIG. 6 is a diagram detailing a front view of the retention support mechanism of FIGS. 4-5 in a docket position.

### DETAILED DESCRIPTION

Exemplary and illustrative embodiments of the invention are described below. In the interest of clarity, not all features of an actual implementation are described in this specification, for those skilled in the art will appreciate that in the development of any such actual embodiment, numerous implementation specific decisions are made to achieve specific goals, such as compliance with system-related and business related constraints, which vary from one implementation to another. Furthermore, it will be appreciated that such a development effort might be complex and time-consuming, but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present invention will now be described with reference to the attached figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase.

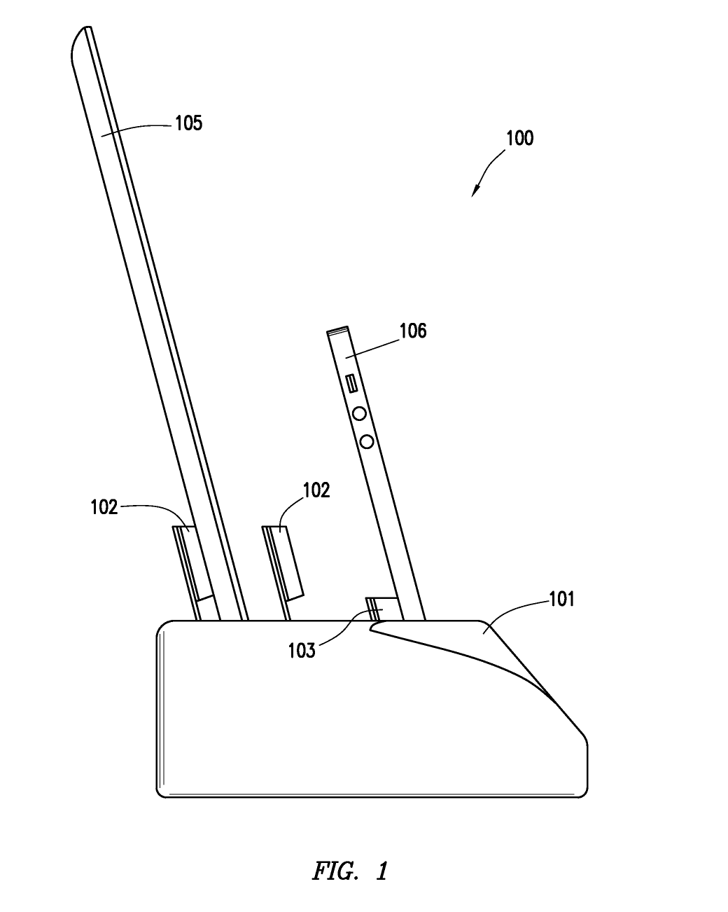

In view of the above background discussion on docking techniques and associated present day mechanisms that are employed to dock and/or charge , a discussion of the present invention will now be presented with reference to FIGS. 1-6.

Turning to FIG. 1, a diagram 100 is presented illustrating a side view of a docking mechanism according to the present invention featuring an exemplary tablet computer 105 and a mobile telephone 106 shown in corresponding docked positions. The docking mechanism includes a housing 101 having a top face into which the computer 105 and telephone 106 are docked. The housing also includes two side faces, one of which is shown in the side diagram 100, a bottom face, a front face, and a rear face. Preferably, the housing may be fabricated from a variety of colored acrylonitrile butadiene styrene (ABS) plastics and silicones. All parts will be injection/compression molded. All additional hardware such as screws, springs and wires will be supplied and assembled. The docking mechanism may further include one or more tablet computer retention mechanisms 102. The docking mechanism may additionally include one or more mobile telephone retention mechanisms 103. The docking mechanism (i.e., the “dock”) may include tablet computer connectors (not shown) corresponding to each of the one or more tablet computer retention mechanisms 102 and mobile telephone connectors (not shown) corresponding to each of the one or more mobile telephone retention mechanisms 103. The tablet computer connectors and the mobile telephone connectors are configured to mate with corresponding connectors disposed on each of the one or more tablet computers 105 and mobile telephones 106 that may be installed into the dock. The corresponding docking connectors are configured to provide signaling connectivity for each of the tablet computers 105 and mobile telephones 106 to support standards-compliant charging of batteries therein and may optionally provide signaling connectivity to support reading/writing of data from/to the tablet computers 105 and mobile telephones 106 for purposes of backup, synchronization, and the like, as are well known in the art.

In one embodiment, the dock and retention mechanisms 102-103 are configured to provide for docking support and charging/connectivity with one or more WAD® tablet computers and one or more iPHONE® mobile telephones manufactured by APPLE® Computer Corporation. Other embodiments contemplate configuration of the dock and retention mechanisms 102-103 to provide for docking support and charging/connectivity with one or more ANDROID™ tablet computers and one or more ANDROID mobile telephones manufactured by any of the well known ANDROID manufacturers. Further embodiments comprehend configuration of the dock and retention mechanisms 102-103 to provide for docking support and charging/connectivity with virtually any combination of present day mobile telephones and tablet computers. As one skilled in the art will appreciate from the disclosure hereinbelow, differences in charging and connectivity from configuration to configuration of the dock involve changes to corresponding connectors and electronics (not shown) within the dock to provide for compatibility with particular mobile telephones and tablet computers.

The present inventors also note that although the disclosure herein is directed toward a dock that provides for docking support and charging/connectivity with two tablet computers and two mobile telephones, such a configuration is exemplary only and is provided to teach aspects of the present invention, for the present invention contemplates configurations having a single phone retention mechanism 103, a single tablet computer retention mechanism 102, and various combinations of phone retention mechanisms 103 and tablet retention mechanisms 102.

As is alluded to above, it is a feature of the present invention to provide a dock that presents a sleek and slimline appearance. Accordingly, the retention mechanisms 102-103 are configured to fully retract into the cavity of the dock such that no part of the retention mechanisms 102-103 protrude above the top face of the dock when the tablet computer 105 and mobile phone 106 are removed. Thus, the tablet computer retention mechanism 102 absent a tablet computer 105 is shown in a forced docked position for illustration purposes only; in normal operation, the retention mechanism 102 would be in a retracted position and would not be visible from a side view.

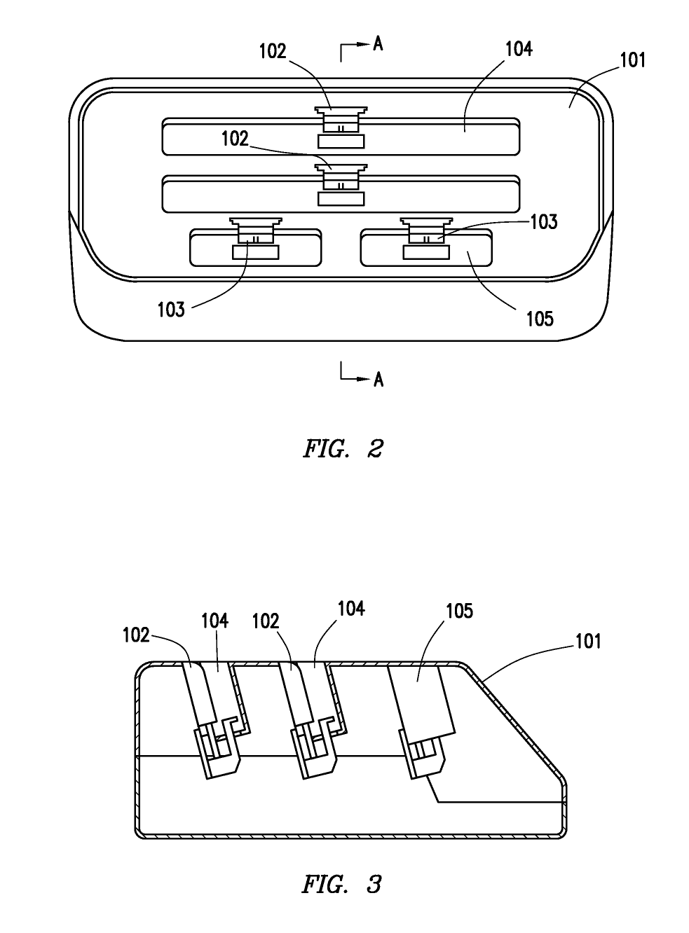

Now referring to FIG. 2, a diagram 200 is presented depicting a top view of the docking mechanism of FIG. 1. The dock housing is depicted having tablet slots 104 into which tablet computers may be docked and phone slots 105 into which mobile telephones may be docked. The tablet slots 104 and phone slots 105 are sized to allow for docking of tablet computers and mobile telephones in accordance with the specific configuration of the dock that is embodied.

The diagram 200 also depicts a tablet computer retention mechanism 102 disposed within each of the tablet slots 104 and a mobile telephone retention mechanism 103 disposed within each of the phone slots 105.

Operationally, when a phone or tablet computer is docket into the slots 103-104, respective retention mechanisms 105-106 pivot along a vertical axis such that corresponding back support mechanisms protrude upward through the top face of the dock to provide for support of the phone or tablet computer. When the phone or tablet computer is removed from the dock, the back support mechanisms retract downwards into the dock housing 101 such that they do not protrude past the plane of the top face.

Turning to FIG. 3, a diagram 300 is presented featuring a cutaway view of the docking mechanism of FIG. 2 taken along axis A-A. The diagram 300 depicts the housing 101 with tablet computer slots 104 and mobile phone slot 105 ready for docking. Because no devices are docked, the retention mechanisms 102, 103 are in a retracted position. Accordingly, the tablet computer retention mechanisms 102 are visible within the computer slots 104, but the mobile phone retention mechanism 103 cannot be seen within the phone slot 105 due to the orientation of axis A-A.

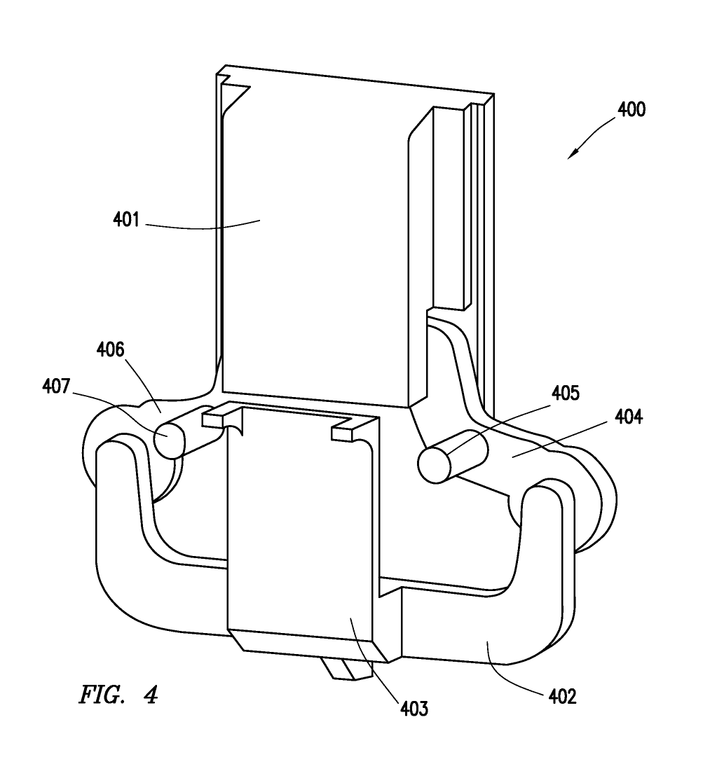

Now turning to FIGS. 4-6, diagrams 400-600 are presented showing a perspective view, a front view in a retracted position, and a front view in a docked position, respectively, of a retention support mechanism according to the present invention, such as might be employed in the docking mechanism of FIGS. 1-3. The retention support mechanism may be employed as a tablet computer retention mechanism 102 or as a mobile telephone retention mechanism 103, where the difference between the two mechanisms 102-103 is in the size of individual elements that make up the retention support mechanism., as one skilled in the art will appreciate from the description below.

The retention support mechanism includes an upper support arm 401 that is coupled to a first rotating arm 406 and a second rotating arm 404. The first and second rotating arms 406, 404 are coupled to a lower connecting arm 402. The retention support mechanism may be fabricated to be assembled without using any screws. Each piece 401-402, 404, 406 may be secured with a plastic plug. The plug may also be injection molded out of ABS plastic as are all of the retention pieces 401-402, 404, 406. Each retention arm 401-402, 404, 406 is attached on a concentric axis to its coupled piece 401-402, 404, 406. This allows the retention mechanism to move freely up and down.

A front face of the upper support arm 401 is sized to provide support to the back of a tablet computer or to a mobile telephone when in a docked position in the docking mechanism. In a tablet computer retention mechanism embodiment, the dimensions of the upper support arm 401 are approximately 50 mm vertically from the bottom of the device. In a mobile telephone retention mechanism embodiment, the dimensions of the upper support arm 401 are approximately 30 mm vertically from the bottom of the device.

The lower connecting arm 402 includes a corresponding connector guide 403 that is dimension to enable a corresponding connector (not shown) permanently affixed to the housing 101 to mate with a connector on a device (i.e., tablet computer or mobile telephone) when the retention support mechanism is in a docket position. Operationally, a bottom face of the device rests on the top of the corresponding connector guide 403 and, as the first and second rotating levers 406, 404 rotate, the lower connecting arm descends vertically within the housing 101 until the a connector on the device mates with the corresponding connector, thus achieving the docket position.

The first and second rotating arms 406, 404 include first and second mounting elements 407, 405, respectively. The first and second mounting elements 407, 405 are employed to affix the retention support mechanism to the housing 101 while still allowing for rotation of the first and second rotating arms 406, 404 about the points contacted by the first and second mounting elements 407, 405. In one embodiment, the mounting elements 407, 405 comprise snap pins that are pressed into mating orifices in the housing. Other embodiments are contemplated according to well known fabrication processes.

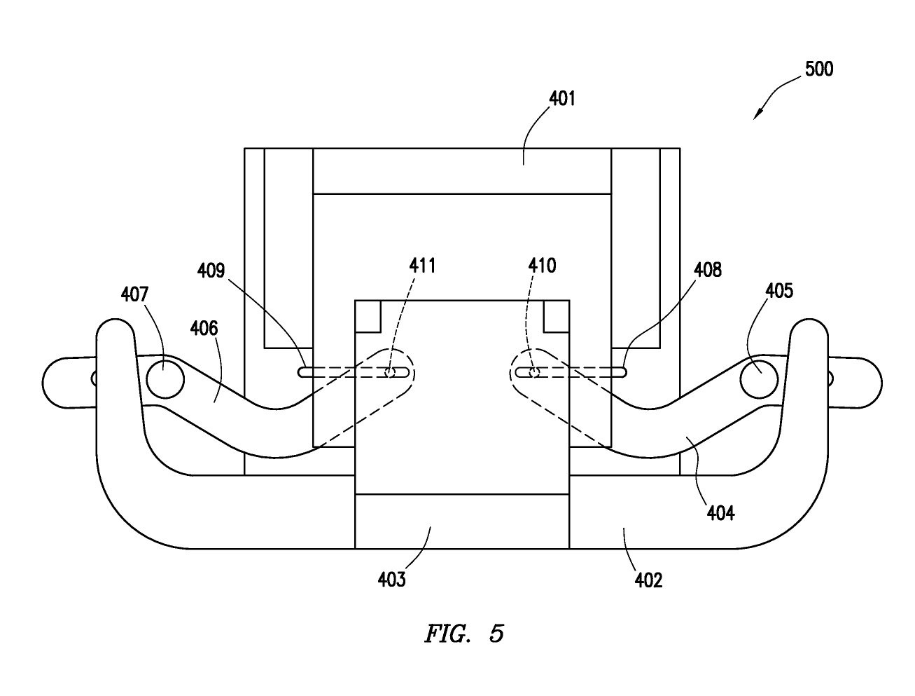

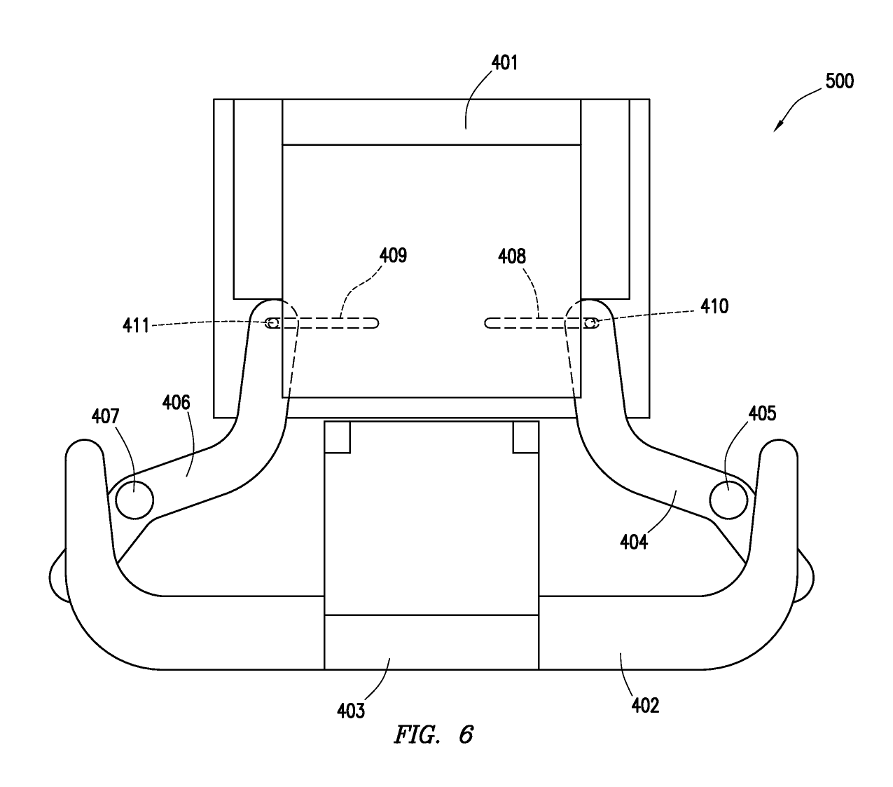

The first and second rotating levers 406, 404 also include travel pins 411, 410 that protrude perpendicularly from the levers 406, 404 into first and second guide grooves 409, 408 in the upper support arm 401. In a docked position, as shown in FIG. 6, the travel pins 411, 410 are in a farthest position within the grooves 409, 408 extended away from the center vertical axis of the upper support arm 401. In a retracted position, as shown in FIG. 5, the travel pins 411, 410 are in a nearest position to the center axis within the grooves 409, 408.

When in a retracted position, the docking mechanism is configured such that the upper support arm 401 is within the cavity of the housing 101, and no portion of the upper support arm 401 protrudes past the top face of the housing 101. As a device is inserted into the docking mechanism, the lower connecting arm 402 travels in a downward direction within the housing 101 causing the first and second rotating levers 406, 404 to rotate about the points of the first and second mounting elements 407, 405, respectively. The rotating actions cause the first and second rotating levers 406, 404 to push the upper support arm 401 in an upward direction through a slot (e.g., slot 104 or slot 105) in the housing 101 and travel pins 411, 410 to slide within the grooves 409, 408 until they cause the rotating actions to stop when the pins 411, 410 reach the farthest position away from the center vertical axis. In concert, when the pins 411, 410 reach the farthest position, the docking mechanism is configured such that the bottom connecting arm 402 is in a position such that the corresponding connector is at an optimum mating point for a connector on the device. When so “docked”, the device may be charged/synchronized according to known methods.

In addition, orientation angles of retention support mechanism according to the present invention are configured to hold a docked device in a optimum position relative to its corresponding connector within the docking mechanism for best connection and to minimize torque on the corresponding connector. Moreover, the orientation angles and dimensions of the upper support arm 401 are configured to provide support to the back of a docked device so that a user can press controls and/or touchscreen on the front of the device with the appropriate amount of force without dislodging the device from the docking mechanism. In one embodiment the retention mechanism is angled at approximately 15 degrees back from a vertical axis.

Then the device is removed from the docking mechanism, the weight of the upper support arm 401 is configured such that it causes the first and second rotating arms 406, 404 to rotate in directions opposite from those corresponding to a docking process, thus causing the lower connecting arm 402 to move upward within the housing, and causing the upper support arm 401 to retract back into the slot in the housing 101 until the travel pins 411, 410 reach a retracted position in the grooves 409, 408. At this point, no portion of the upper support arm 401 protrudes past the plane defined by the top face of the housing 101. That is, when retracted, the upper support arm 401 is fully within the cavity of the housing, lending a sleek and slimline look to the docking mechanism.

The particular embodiments disclosed above are illustrative only, and those skilled in the art will appreciate that they can readily use the disclosed conception and specific embodiments as a basis for designing or modifying other structures for carrying out the same purposes of the present invention, and that various changes, substitutions and alterations can be made herein without departing from the scope of the invention as set forth by the appended claims.

What is claimed is:

1. A docking apparatus, comprising:
a housing, configured to couple to and provide back support for a device when said device is inserted in said housing in a docked position; and
a retention support mechanism, coupled to said housing, said retention support mechanism comprising:
an upper support arm and a lower connecting arm, wherein, upon insertion of said device in a slot within a top face of said housing, said upper support arm is raised and said lower connecting arm is lowered, and wherein, when said device travels to said docked position, said lower connecting arm enables a connector on said device to couple to a corresponding connector within said housing, and said upper arm is raised to a point above said top face of said housing to support a back of said device, and wherein, when said device is removed, said upper support arm retracts fully into said housing such that no part of said upper support arm protrudes past a plane defined by said top face.

2. The docking apparatus as recited in claim 1, wherein said corresponding connector is configured to provide signaling connectivity for said device to support standards-compliant charging of batteries disposed within said device.

3. The docking apparatus as recited in claim 2, wherein said corresponding connector is further configured to provide signaling connectivity to support reading/writing of data from/to said device.

4. The docking apparatus as recited in claim 1, wherein said device comprises a tablet computer.

5. The docking apparatus as recited in claim 1, wherein said device comprises a mobile telephone.

6. The docking apparatus as recited in claim 1, wherein said retention support mechanism further comprises:
a left rotating lever and a right rotating lever, both coupled to said housing, said upper support arm, and said lower connecting arm, wherein, upon insertion of said device into said slot, both of said rotating levers rotate about points of coupling to said housing, causing said upper support arm to be raised.

7. The docking apparatus as recited in claim 6, wherein force of insertion of said device causes said lower connecting arm to lower and said left and right rotating levers to rotate.

8. A docking apparatus, comprising:
a housing, configured to couple to and provide back support for each of a plurality of devices when inserted in said housing in a docked position; and
a plurality of retention support mechanisms, coupled to said housing, each of said plurality of retention support mechanisms comprising:
an upper support arm and a lower connecting arm, wherein, upon insertion of one of said plurality of devices in a slot within a top face of said housing, said upper support arm is raised and said lower connecting arm is lowered, and wherein, when said one of said plurality of devices travels to said docked position, said lower connecting arm enables a connector on said one of said plurality of devices to couple to a corresponding connector within said housing, and said upper arm is raised to a point above said top face of said housing to support a back of said one of said plurality of devices, and wherein, when said one of said plurality of devices is removed, said upper support arm retracts fully into said housing such that no part of said upper support arm protrudes past a plane defined by said top face.

9. The docking apparatus as recited in claim 8, wherein said corresponding connector is configured to provide signaling connectivity for said one of said plurality of devices to support standards-compliant charging of batteries disposed within said one of said plurality of devices.

10. The docking apparatus as recited in claim 9, wherein said corresponding connector is further configured to provide signaling connectivity to support reading/writing of data from/to said one of said plurality of devices.

11. The docking apparatus as recited in claim 8, wherein said plurality of devices comprises a plurality of tablet computers.

12. The docking apparatus as recited in claim 8, wherein said plurality of devices comprises a plurality of mobile telephones.

13. The docking apparatus as recited in claim 1, wherein said retention support mechanism further comprises:
a left rotating lever and a right rotating lever, both coupled to said housing, said upper support arm, and said lower connecting arm, wherein, upon insertion of said one of said plurality of devices into said slot, both of said rotating levers rotate about points of coupling to said housing, causing said upper support arm to be raised.

14. The docking apparatus as recited in claim 13, wherein force of insertion of said one of said plurality of devices causes said lower connecting arm to lower and said left and right rotating levers to rotate.

15. A dock, comprising:
a housing, configured to couple to and provide back support for a first device and a second device when inserted in said housing in a docked position, wherein said first and second devices are of a different size and type; and
a first retention support mechanism, coupled to said housing, said first retention support mechanism comprising:
a first upper support arm and a first lower connecting arm, wherein, upon insertion of said first device in a first slot within a top face of said housing, said first upper support arm is raised and said first lower connecting arm is lowered, and wherein, when said first device travels to said docked position, said first lower connecting arm enables a first connector on said first device to couple to a first corresponding connector within said housing, and said first upper arm is raised to a point above said top face of said housing to support a first back of said first device, and wherein, when said first device is removed, said first upper support arm retracts fully into said housing such that no part of said first upper support arm protrudes past a plane defined by said top face; and
a second retention support mechanism, coupled to said housing, said second retention support mechanism comprising:
a second upper support arm and a second lower connecting arm, wherein, upon insertion of said second device in a second slot within said top face of said housing, said second upper support arm is raised and said second lower connecting arm is lowered, and wherein, when said second device travels to said docked position, said second lower connecting arm enables a second connector on said second device to couple to a second corresponding connector within said housing, and said second upper arm is raised to a point above said top face of said housing to support a second back of said second device, and wherein, when said second device is removed, said second upper support arm retracts fully into said housing such that no part of said second upper support arm protrudes past a plane defined by said top face.

16. The dock as recited in claim 15, wherein said first and second corresponding connectors are configured to provide signaling connectivity for said first and second devices to support standards-compliant charging of batteries disposed within said first and second devices, respectively.

17. The dock as recited in claim 16, wherein said first and second corresponding connectors are further configured to provide signaling connectivity to support reading/writing of data from/to said first and second devices, respectively.

18. The dock as recited in claim 15, wherein said first device comprises a tablet computer and said second device comprises a mobile telephone.

19. The dock as recited in claim 15, wherein said first retention support mechanism further comprises:
a first left rotating lever and a first right rotating lever, both coupled to said housing, said first upper support arm, and said first lower connecting arm, wherein, upon insertion of said first device into said first slot, both of said first rotating levers rotate about points of coupling to said housing, causing said first upper support arm to be raised, and wherein force of insertion of said first device causes said first lower connecting arm to lower and said first left and right rotating levers to rotate.

20. The dock as recited in claim 15, wherein said second retention support mechanism further comprises:
a second left rotating lever and a second right rotating lever, both coupled to said housing, said second upper support arm, and said second lower connecting arm, wherein, upon insertion of said second device into said second slot, both of said second rotating levers rotate about points of coupling to said housing, causing said second upper support arm to be raised, and wherein force of insertion of said second device causes said second lower connecting arm to lower and said second left and right rotating levers to rotate.
